(19) United States
(12) Patent Application Publication
(10) Pub. No.: US 2013/0144799 A1
(43) Pub. Date: Jun. 6, 2013

(54) COMPUTING DEVICE AND METHOD FOR EXTRACTING PATENT REJECTION INFORMATION

(71) Applicants: CHUNG-I LEE, Tu-Cheng (TW); HAI-HONG LIN, Shenzhen City (CN); DE-YI XIE, Shenzhen City (CN); SHUAI-JUN TAO, Shenzhen City (CN); ZHI-QIANG YI, Shenzhen City (CN)

(72) Inventors: CHUNG-I LEE, Tu-Cheng (TW); HAI-HONG LIN, Shenzhen City (CN); DE-YI XIE, Shenzhen City (CN); SHUAI-JUN TAO, Shenzhen City (CN); ZHI-QIANG YI, Shenzhen City (CN)

(73) Assignee: HON HAI PRECISION INDUSTRY CO., LTD., Tu-Cheng (TW)

(21) Appl. No.: 13/600,113

(22) Filed: Aug. 30, 2012

(30) Foreign Application Priority Data
Dec. 1, 2011 (CN) 201110393228.8

(51) Int. Cl. G06Q 50/00

(52) U.S. Cl. 705/310

(57) ABSTRACT

A computing device extracts claims, patent law clauses, and prior art documents from an Office action document according to preset regular expressions, and stores the extracted claims, patent law clauses, and prior art documents in an array stored in a storage unit of the computing device. The computing device identifies rejected claims of the Office action document from the extracted claims, and searches involved patent law clauses and prior art documents regarding the rejected claims in the Office action document. The computing device records each identified rejected claim with involved patent law clauses and prior art documents in the storage unit, according to importance ratings of the rejected claims and the relationships.

### BACKGROUND

1. Technical Field

Embodiments of the present disclosure generally relate to data processing technology, and particularly to a computing device and a method for extracting patent rejection information from an Office action document.

2. Description of Related Art

An Office action is a document written by an examiner in a patent examination procedure and mailed to an applicant for a patent application. The Office action document often describes rejection information about the patent application. However, the description in the Office action document may be very long, so reading the Office action document may use a lot of time, and it is not convenient to quickly obtain the rejection information.

### BRIEF DESCRIPTION OF THE DRAWINGS

FIG. 1 is a block diagram of one embodiment of a computing device including an extracting unit.

FIG. 2 is a block diagram of one embodiment of function modules of the extracting unit in FIG. 1.

FIG. 3 is a flowchart of one embodiment of a method for extracting patent rejection information from an Office action document.

FIG. 4 is a schematic diagram of one embodiment of a patent rejection information list.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

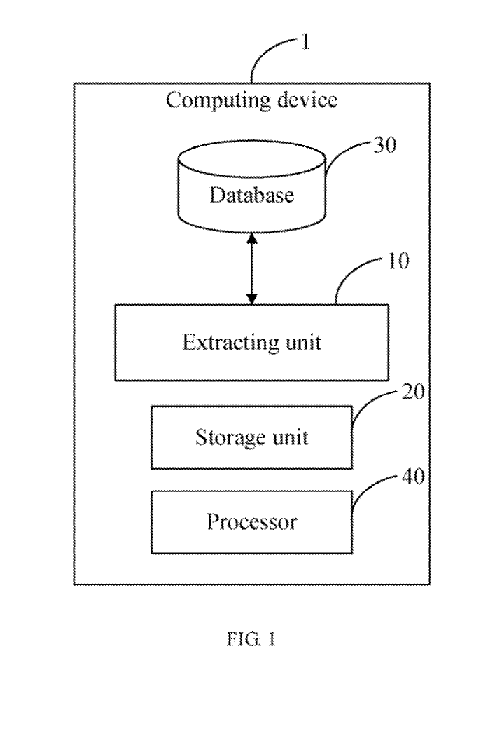

FIG. 1 is a block diagram of one embodiment of a computing device 1. The computing device 1 includes an extracting unit 10 for extracting patent rejection information from an Office action document. The computing device 1 further includes a storage unit 20, a database 30, and a processor 40. The storage unit 20 stores the Office action documents.

The database 30 stores the extracted patent rejection information and importance ratings of claims in patent application documents corresponding to the Office action documents. The patent rejection information includes rejected claims, and patent law clauses used to reject the claims, and prior art documents used to reject the claims in the Office action documents.

The importance ratings of claims include independent claims and dependent claims. In the patent application documents, the importance ratings of claims may be determined according to preset strings at the beginning of the claims. For example, in U.S. patent application documents, the beginning of the independent claims may be described as “A computing device” or “An electronic device”, so corresponding preset string is “A” or “An”; the beginning of the dependent claims may be described as “The computing device as claimed in claim 1”, so corresponding preset string is “The”.

It is understood that in other embodiments, the database 30 may be in other storage devices electronically connected to the computing device 1, and the extracted patent rejection information and importance ratings of claims may be separately stored in different databases.

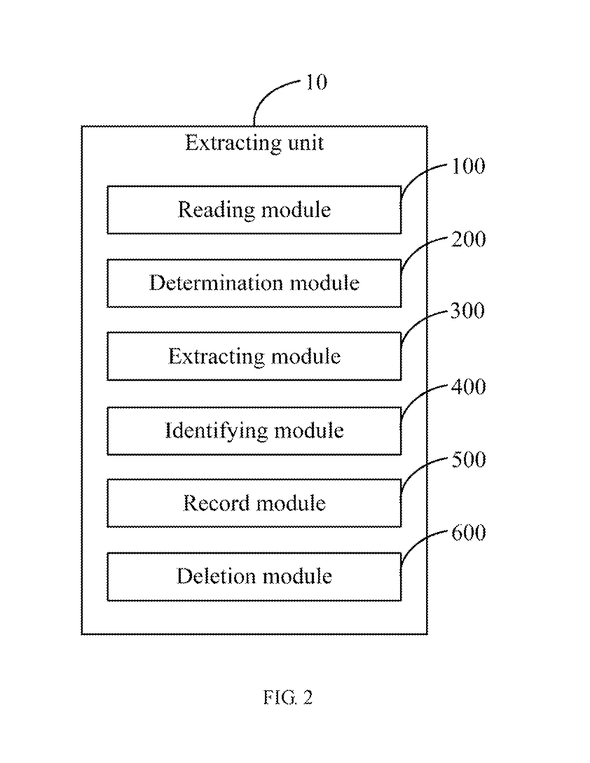

In one embodiment, the extracting unit 10 may include one or more function modules (as shown in FIG. 2). The one or more function modules may comprise computerized code in the form of one or more programs that are stored in the storage unit 20, and executed by the processor 40 to provide the functions of the extracting unit 10. The storage unit 20 is a dedicated memory, such as an EPROM or a flash memory.

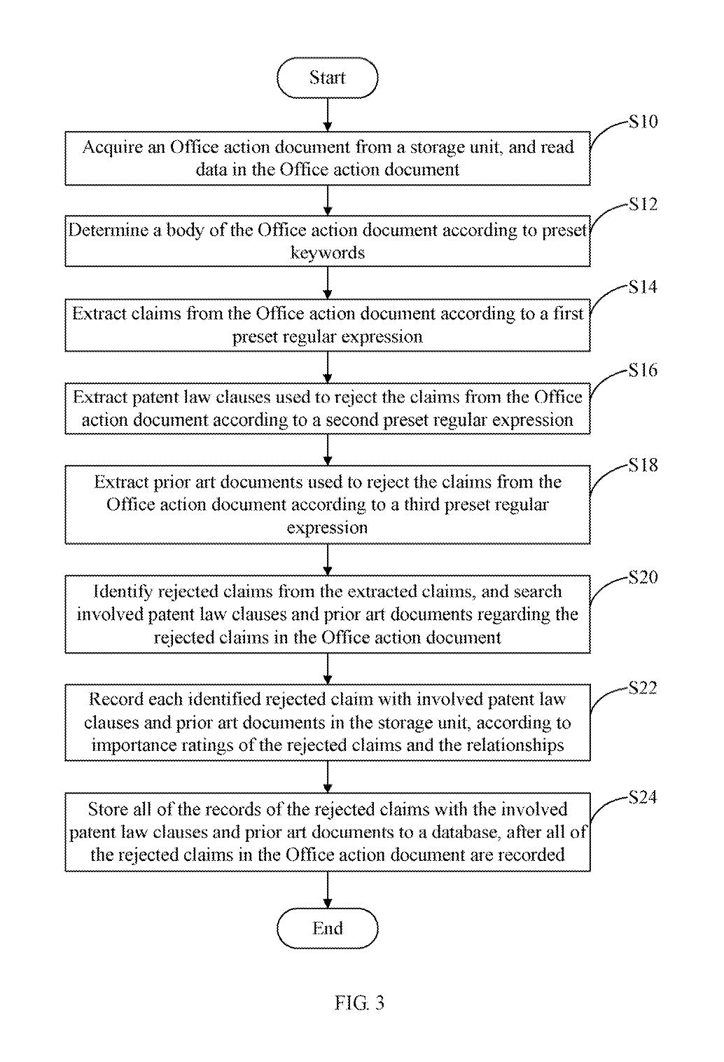

FIG. 2 is a block diagram of one embodiment of the function modules of the extracting unit 10. In one embodiment, the extracting unit 10 includes a reading module 100, a determination module 200, an extracting module 300, an identifying module 400, a record module 500, and a deletion module 600. A detailed description of the functions of the modules 100-600 is given below in the description regarding FIG. 3.

FIG. 3 is a flowchart of one embodiment of a method for extracting patent rejection information from an Office action document. Depending on the embodiment, additional steps may be added, others removed, and the ordering of the steps may be changed. For example, the ordering of step S14, S16, and S18 can be changed.

In step S10, the reading module 100 acquires an Office action document from the storage unit 20, and reads data in the Office action document. The Office action document may be in an electronic format, such as WORD, PDF, JPG, or TIF format.

In step S12, the determination module 200 determines a body of the Office action document according to preset keywords. For example, in US Office action documents, the keywords may be “Detailed Action”, for starting the body, and “Notice of References Cited Application”, for ending the body.

In step S14, the extracting module 300 extracts claims from the Office action document according to a first preset regular expression, and stores the extracted claims in an array stored in the storage unit 20. The first preset regular expression may be an expression about characters frequently used in the Office action documents to describe claims. For example, in US Office action documents, the claims are usually described as “Claims 2, 3, 15 and 16”, so corresponding first preset regular expression is “Claims?\s*\d.*”.

In step S16, the extracting module 300 extracts patent law clauses used to reject the claims from the Office action document according to a second preset regular expression, and stores the extracted patent law clauses in the array stored in the storage unit 20. The second preset regular expression may be an expression about characters frequently used in the Office action documents to describe involved patent law clauses. For example, in US Office action documents, the patent law clauses are usually described as “35 U.S.C. 103(a)”, so corresponding second preset regular expression is “\d{2}\s*USC\s*§\s*\d{3}\s*(\(\s*\w\s*\))?\s*-?\s*(\(\s*\w\s*\))?|\d{2}\s*U.S.C.\s*\d{3}\s*(\(\s*\w\s*\))?\s*-?\s*(\(\s*\w\s*\))?|\d{2}\s*CFR\s*[\d.]{3,}\s*(\(\s*\w\s*\))?\s*-?\s*(\(\s*\w\s*\))?”.

In step S18, the extracting module 300 extracts prior art documents used to reject the claims from the Office action document according to a third preset regular expression, and stores the extracted prior art documents in the array stored in the storage unit 20. The third preset regular expression may be an expression about characters frequently used in the Office action documents to describe involved prior art documents. For example, in US Office action documents, a prior art document may be described as “US 2009/0196071”, so corresponding first preset regular expression is “(PCTV)?(U\.?[S5]\.?\s*|K\.?R\.?\s*|T\.?W\.?\s*|E\.?P\.?\s*|C\.?N\.?\s*|\.?P\.?\s*|Science\. ?\s*)?(P[GAU][PTB]\w*\.?\s*)?(NO\.?\s*:?\s*|Application\s*)?(Publication\s*)?(NO\.?\s*: ?\s*)?\d[̂a-zA-Z]{3,13}\d{2}(\s*\)?4{0,2}\d?\s*)?”.

In step S20, the identifying module 400 identifies rejected claims from the extracted claims, and searches involved patent law clauses and prior art documents regarding the rejected claims in the Office action document. More specifically, the identifying module 400 determines whether there is a preset string after each extracted claim in a preset area (e.g., a current page). For example, in US Office action documents, the rejected claims are usually described as “Claims 2, 3, 15 and 16 are rejected under 35 U.S.C. 103(a) as being unpatentable over Shimura et al.(US 2008/0130317)”, so corresponding preset string is “rejected under”.

If there is the preset string after the extracted claim in the preset area, the identifying module 400 determines the extracted claim is the rejected claim, and searches the involved patent law clauses and prior art documents regarding the rejected claim in the Office action document. For example, if “Claims 2, 3, 15 and 16 are rejected under 35 U.S.C. 103(a) as being unpatentable over Shimura et al.(US 2008/0130317)”, the rejected claims are “Claims 2, 3, 15”, the involved patent law clause is “35 U.S.C. 103(a)”, and the involved prior art document is “US 2008/0130317”.

If there is not the preset string after the extracted claim in the preset area, the identifying module 400 determines the extracted claim is not the rejected claim, and deletes the extracted claim from the array in the storage unit 20.

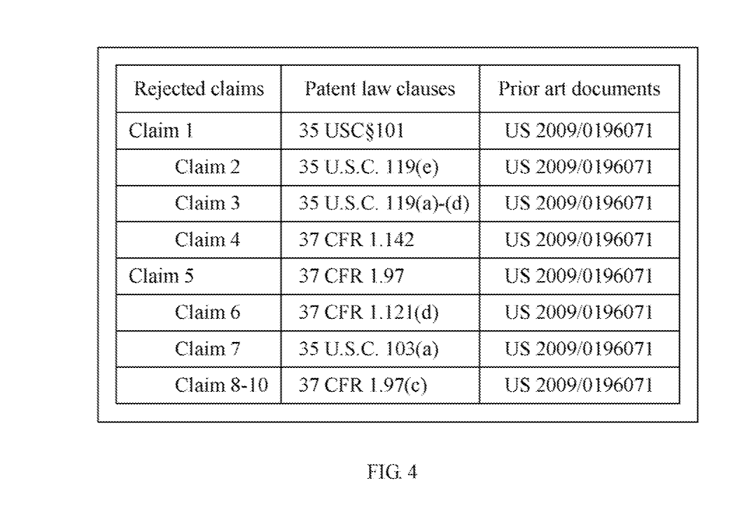

In step S22, the record module 500 records each identified rejected claim with involved patent law clauses and prior art documents in the storage unit 20, according to the importance ratings of the rejected claims and the relationships. The record module 500 creates a patent rejection information list in the storage unit 20, and records each identified independent rejected claim with involved patent law clauses and prior art documents in the patent rejection information list, and records identified dependent rejected claims attached to the identified independent rejected claim with involved patent law clauses and prior art documents behind the independent rejected claim record in the patent rejection information list (as shown in FIG. 4).

For example, the record module 500 records “Claim 1”(an identified independent rejected claim) with involved patent law clause “35 USC§101” and prior art documents “US 2009/0196071” in the patent rejection information list. Then the record module 500 records identified dependent rejected claim “Claim 2” attached to “Claim 1” with involved patent law clause “35 U.S.C. 119(e)” and prior art document “US 2009/0196071” behind the “Claim 1” record.

In step S24, the deletion module 600 stores all of the records of the rejected claims with the involved patent law clauses and prior art documents into the database 30, after all of the rejected claims in the Office action document are recorded, and deletes all of the records and data in the array.

Although certain inventive embodiments of the present disclosure have been specifically described, the present disclosure is not to be construed as being limited thereto. Various changes or modifications may be made to the present disclosure without departing from the scope and spirit of the present disclosure.

1. A method of a computing device being executed by a processor of the computing device, the method comprising:
(a) acquiring an Office action document from a storage unit of the computing device, and reading data in the Office action document;
(b) determining a body of the Office action document according to preset keywords by using the processor;
(c) extracting claims, patent law clauses, and prior art documents from the Office action document according to preset regular expressions by using the processor, and storing the extracted claims, patent law clauses, and prior art documents in an array stored in the storage unit by using the processor;
(d) identifying rejected claims of the Office action document from the extracted claims by using the processor, and searching involved patent law clauses and prior art documents regarding the rejected claims in the Office action document by using the processor; and
(e) recording each identified rejected claim with involved patent law clauses and prior art documents in the storage unit by using the processor, according to importance ratings of the rejected claims and the relationships.

2. The method as claimed in claim 1, wherein after step (e) the method further comprises:
storing all of the records of the rejected claims with the involved patent law clauses and prior art documents into a database, after all of the rejected claims in the Office action document are recorded, deleting all of the records and data in the array.

3. The method as claimed in claim 1, wherein step (d) further comprises:
determining whether there is a preset string after each extracted claim in a preset area of the Office action document;
determining the extracted claim is the rejected claim, and searching the involved patent law clauses and prior art documents regarding the rejected claim in the Office action document, in response that there is the preset string after the extracted claim in the preset area; and
determining the extracted claim is not the rejected claim, and deleting the extracted claim from the array in the storage unit, in response that there is not the preset string after the extracted claim in the preset area.

4. The method as claimed in claim 1, wherein the importance ratings of the rejected claims include independent claims and dependent claims.

5. The method as claimed in claim 4, wherein step (e) further comprises:
recording each identified independent rejected claim with involved patent law clauses and prior art documents in a patent rejection information list stored in the storage unit; and
recording identified dependent rejected claims attached to the identified independent rejected claim with involved patent law clauses and prior art documents behind the independent rejected claim record in the patent rejection information list.

6. A non-transitory storage medium storing a set of instructions, the set of instructions capable of being executed by a processor of a computing device, to perform a method comprising:
(a) acquiring an Office action document from a storage unit of the computing device, and reading data in the Office action document;
(b) determining a body of the Office action document according to preset keywords;
(c) extracting claims, patent law clauses, and prior art documents from the Office action document according to preset regular expressions, and storing the extracted claims, patent law clauses, and prior art documents in an array stored in the storage unit;
(d) identifying rejected claims of the Office action document from the extracted claims, and searching involved patent law clauses and prior art documents regarding the rejected claims in the Office action document; and
(e) recording each identified rejected claim with involved patent law clauses and prior art documents in the storage unit, according to importance ratings of the rejected claims and the relationships.

7. The non-transitory storage medium as claimed in claim 6, wherein after step (e) the method further comprises:
storing all of the records of the rejected claims with the involved patent law clauses and prior art documents into a database, after all of the rejected claims in the Office action document are recorded, deleting all of the records and data in the array.

8. The non-transitory storage medium as claimed in claim 6, wherein step (d) further comprises:
determining whether there is a preset string after each extracted claim in a preset area of the Office action document;
determining the extracted claim is the rejected claim, and searching the involved patent law clauses and prior art documents regarding the rejected claim in the Office action document, in response that there is the preset string after the extracted claim in the preset area; and
determining the extracted claim is not the rejected claim, and deleting the extracted claim from the array in the storage unit, in response that there is not the preset string after the extracted claim in the preset area.

9. The non-transitory storage medium as claimed in claim 6, wherein the importance ratings of the rejected claims include independent claims and dependent claims.

10. The non-transitory storage medium as claimed in claim 9, wherein step (e) further comprises:
recording each identified independent rejected claim with involved patent law clauses and prior art documents in a patent rejection information list stored in the storage unit; and
recording identified dependent rejected claims attached to the identified independent rejected claim with involved patent law clauses and prior art documents behind the independent rejected claim record in the patent rejection information list.

11. A computing device, the computing device comprising:
a storage unit;
at least one processor; and
one or more programs stored in the storage unit, executable by the at least one processor, the one or more programs comprising:
a reading module that acquires an Office action document from the storage unit, and reads data in the Office action document;
a determination module that determines a body of the Office action document according to preset keywords;
an extracting module that extracts claims, patent law clauses, and prior art documents from the Office action document according to preset regular expressions, and stores the extracted claims, patent law clauses, and prior art documents in an array stored in the storage unit;
an identifying module that identifies rejected claims of the Office action document from the extracted claims, and searches involved patent law clauses and prior art documents regarding the rejected claims in the Office action document; and
a record module that records each identified rejected claim with involved patent law clauses and prior art documents in the storage unit, according to importance ratings of the rejected claims and the relationships.

12. The computing device as claimed in claim 11, wherein the computing device further comprises a database, and the one or more programs further comprises:
a deletion module that stores all of the records of the rejected claims with the involved patent law clauses and prior art documents into the database, after all of the rejected claims in the Office action document are recorded, deletes all of the records and data in the array.

13. The computing device as claimed in claim 11, wherein the identifying module further:
determines whether there is a preset string after each extracted claim in a preset area of the Office action document;
determines the extracted claim is the rejected claim, and searches the involved patent law clauses and prior art documents regarding the rejected claim in the Office action document, in response that there is the preset string after the extracted claim in the preset area; and
determines the extracted claim is not the rejected claim, and deletes the extracted claim from the array in the storage unit, in response that there is not the preset string after the extracted claim in the preset area.

14. The computing device as claimed in claim 11, wherein the importance ratings of the rejected claims include independent claims and dependent claims.

15. The computing device as claimed in claim 14, wherein the record module further:
records each identified independent rejected claim with involved patent law clauses and prior art documents in a patent rejection information list stored in the storage unit; and
records identified dependent rejected claims attached to the identified independent rejected claim with involved patent law clauses and prior art documents behind the independent rejected claim record in the patent rejection information list.
